(19) United States
(12) Patent Application Publication
(10) Pub. No.: US 2022/0221368 A1
(43) Pub. Date: Jul. 14, 2022

(54) System And Method For Determining An Indication Of A Presence Of A Leak Of Hazardous Material Using A Trained Classification Module

(71) Applicant: Les Systemes Flyscan Inc., Quebec (CA)

(72) Inventor: Eric Bergeron, Quebec (CA)

(21) Appl. No.: 17/609,373

(22) PCT Filed: May 4, 2020
(86) PCT No.: PCT/CA2020/050596

§ 371 Date: Nov. 6, 2021

Related U.S. Application Data
(60) Provisional application No. 62/844,357, filed on May 7, 2019.

(51) Int. Cl. G01M 3/38

(52) U.S. Cl. CPC G01M 3/38

(57) ABSTRACT

A method and system for determining an indication of a presence of a leak of hazardous material includes displacing a first sensor system over a monitored geographical region, capturing first sensed data of the monitored geographic region using the sensor system during the displacement, and classifying the sensed data using a classification module to identify sensed samples having an indication of presence of leak of hazardous material. The classification module is trained according to a training dataset that is automatically annotated based on a detection method applied to second sensed data captured by a second sensor system of the monitored geographic region. In a training phase, the first and second sensor system are displaced over the monitored geographic area, and for each of the second samples, the indication of presence of a leak is automatically determined and used to automatically annotate a corresponding sample captured by the first sensor system. The classification module can be configured to distinguish true positives of leak detection from false positives of leak detection.

### RELATED PATENT APPLICATION

The present application claims priority from U.S. provisional patent application No. 62/844,357, filed May 7, 2019 and entitled “System And Method For Determining An Indication Of A Presence Of A Leak Of Hazardous Material Using A Trained Classification Module”, the disclosure of which is hereby incorporated by reference in its entirety.

### TECHNICAL FIELD

The present disclosure generally relates to a method of determining an indication of a presence of a leak of hazardous material by capturing passively sensed data of a monitored geographic location and classifying the sensed data using a trained leak detection classification module to output indications of presence of leak, and more particularly, wherein the leak detection classification module is trained from an annotated training dataset that is validated using a detection method applied to second actively sensed data captured by another sensor system. The leak detection classification module may be configured to distinguish between true positives and false positives detected within the passively captured sensed data.

### BACKGROUND

Various techniques exist for detecting spills and/or leaks of hazardous material, such as petroleum products. One significant source of spills is hydrocarbons leaks from production infrastructure and pipelines. Members of the public expect operators to have environmentally safe infrastructures in order to avoid leaks that could possibly contaminate soil and/or water. Leaks can also be caused by unauthorized excavation, structural degradation due to corrosion and/or soil movement. To respond to these threats and comply with various regulations, operators have developed techniques for detecting leaks of petroleum products and for implementing inspections of pipeline right-of-ways.

Existing techniques include monitoring pressure drops along a pipeline using pressure sensors placed along the pipeline, acoustic detection apparatus that listen for acoustic signals indicative of a leak, and airborne right-of-way inspections using small aircrafts and trained observers.

There continues to be great interest in developing improved systems for monitoring and detecting leaks of hazardous materials, such as petroleum products from production infrastructures and pipelines.

### SUMMARY

According to one aspect, there is provided a method of determining an indication of a presence of a leak of hazardous material. The method includes displacing a first sensor system over a monitored geographic region, capturing first sensed data of the monitored geographic region using the sensor system during displacement of the first sensor system, and classifying the sensed data using a computer-implemented classification module, thereby identifying one or more sensed samples of the sensed data having an indication of the presence of leak of hazardous material, the classification module being trained according to a training captured sensed dataset having samples being automatically annotated to indicate presence or non-presence of a leak based on applying a detection method to second sensed data captured by a second sensor system of the monitored geographic region.

According to another aspect, there is provided a method for determining an indication of a presence of a leak of hazardous material. The method includes displacing a first sensor system and a second sensor system over a monitored geographic area, during displacement over the monitored geographic area, capturing sensed data at a plurality of geographic locations of the geographic area using the first sensor system and the second sensor system, for each geographic location, the first sensor system outputting a first sensed sample and the second sensor system outputting a corresponding second sensed sample, for each of a subset of the second samples:
automatically determining an indication of a presence of a leak for a given geographical location based on the second sensed sample captured for said given geographical location;
automatically annotating the first sensed sample corresponding to the second sensed sample with the indication of presence of leak determined for the second sensed sample; and
training a computer-implemented classification module based on the first sensed samples having been annotated according to the determination of indication of presence of leak made based on the second sensed samples.

According to yet another aspect, there is provided a system for determining an indication of a presence of a leak of hazardous material. The system includes a first sensor subsystem configured to capture first sensed data of a monitored geographic region and a computer-implemented classification module configured to classify the sensed data to identify one or more sensed samples of the sensed data having an indication of the presence of leak of hazardous material, the classification module being trained according to a training captured sensed dataset having samples being automatically annotated to indicate presence or non-presence of a leak based on applying a detection method to second sensed data captured by a second sensor subsystem of the monitored geographic region.

According to yet another aspect, there is provided a system for determining an indication of a presence of a leak of hazardous material. The system includes a first sensor subsystem configured to capture first sensed data of a plurality of geographic locations of a monitored geographic region, a second sensor subsystem configured to capture second sensed data of the plurality of geographic locations of the monitored geographic region, for each geographic location, the first sensor subsystem outputting a first sensed sample and the second sensor subsystem outputting a corresponding second sensed sample; and a computer-implemented classification module configured to classify the first sensed data to identify one or more sensed samples of the sensed data having an indication of the presence of leak of hazardous material, the classification module being trained according to the first sensed samples having been automatically annotated according to the detection of indication of presence of leak made based on the second sensed samples.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a schematic diagram of the operational modules and/or subsystems of a leak detection system according to an example embodiment;

FIG. 2 illustrates a flowchart showing the operational steps of a method for determining an indication of a presence of a leak of hazardous material using the trained leak detection classification module according to an example embodiment;

FIG. 3 illustrates a schematic diagram of the operational modules and/or subsystems of a leak detection system in its training/calibration configuration according to an example embodiment;

FIG. 4A illustrates a flowchart showing the operational steps of a method for determining an indication of a presence of a leak of hazardous material in a training mode according to an example embodiment;

FIG. 4B illustrates a flowchart showing the operational steps of a method for annotating first sensed data captured by the first sensing subsystem to indicate whether the samples of the first sensed data are true positive detections or false positive detections according to an example embodiment; and

FIG. 5 illustrates a schematic diagram showing the logical flow of sensed data and processed sensed for training the leak detection classification module according to an example embodiment.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

“Indication of a presence of leak of hazardous material” herein refers signatures in sensed data captured of a geographic location that is representative of a sufficiently high likelihood of leak of material from equipment at the geographic location. The likelihood of the leak is sufficiently high such that further examination is required. Such further examination may include sending ground-based personnel to the geographic location to take more detailed observations or measurements. The leak of hazardous material from the equipment, such as pipelines, can present various risks, such as an environmental hazard and/or an operational hazard. As described elsewhere herein, the signatures in the sensed data can be generated in response to excitation from an activation signal.

“Indication of the presence of petroleum-based material” herein refers to signatures in sensed data captured of a geographic location that is representative of a presence of petroleum-based material. This material may include some materials that contain hydrocarbons. The presence of petroleum-based material may be correlated to the presence of a leak of hazardous material, but may not be sufficient, without further processing, to make a high confidence determination of the presence of the leak of hazardous material.

Broadly described, and without limiting various embodiments described herein, systems and method described herein determine an indication of a presence of leak of hazardous material by displacing a first sensor subsystem, which may be passive, over a monitored geographical region and capturing first sensed data during the displacement. Samples of the sensed dataset is classified using a leak detection classification module that is trained using a validated training dataset having been annotated based on a secondary detection method. This secondary detection method can be applied to second sensed data captured by a second sensor subsystem, which may be active. In normal operation, only the first sensor subsystem is displaced and the classification by the leak detection classification module is applied to data captured by that sensor subsystem. In a training/calibration configuration, both the first sensor subsystem and the second sensor subsystem can be displaced and operated to capture data of the same region. The first sensor subsystem and the second sensor subsystem can be displaced on the same vehicle and the first and second sensed data can be captured during the displacement. Alternatively, the first sensor subsystem and the second subsystem can be displaced in separate runs and the first and second sensed data are captured in the separate runs in such a way that the first and second sensed data have a temporal and geographical relationship. Outcomes of the secondary leak detection method applied to data captured by the second sensor subsystem are used to automatically annotate samples of data captured by the first sensor subsystem, and these annotated samples are used to train the leak detection classification module. In one example embodiment, the secondary leak detection method can be used to annotate whether detections made on data captured by the first sensor subsystem are true positives or false positives. This annotated data (i.e. validated training dataset) is then used to train the leak detection classification module such that this module, in operation, is configured to distinguish between true and false detections made on the data captured by the first sensor subsystem.

It was observed that various automatic sensor-based (image-based or other) solutions for detecting the presence of hazardous materials are prone to generating a high rate of false positives. Such solutions can be primarily focused on detecting indications of presence of petroleum-based material. Such a high rate of false positives may be due to other sources in an analyzed area that generate signatures when captured that resemble leak of petroleum. Such sources can be naturally occurring fauna and flora as well as anthropogenic (ex: man made) sources, such as infrastructure and buildings having hydrocarbon content. In the right-of-way field, such false positives can be particularly problematic due to the high cost of carrying out additional verification procedures in response to each instances of the detection of the presence of the leak of hazardous materials. Accordingly, it has been observed that there is a need for a cost-effective solution for monitoring for leaks while having a sufficiently low rate of false positives.

U.S. Pat. No. 10,113,953, which is hereby incorporated by reference, discloses a method and device for determining the presence of a spill of a petroleum product by the detection of a petroleum-derived volatile organic compound (VOC). The method and device described therein uses an active system, namely a UV radiation generator, such as a UV laser, having a wavelength selected specifically (tuned) to target a resonance Raman excitation wavelength of a molecule that has been identified to be indicative of a petroleum product spill. Such molecule can be a VOC, such as benzene, toluene, ethylbenzene, xylene, naphthalene, styrene and any other VOC that may be derived from the petroleum product. The UV radiation generator is operable to illuminate a distant target with an excitation beam having the specific wavelength and the response to the excitation beam is captured as sensed data.

It was observed that the method and device described in U.S. Pat. No. 10,113,953 is effective at detecting leaks of petroleum products while having a low rate of false positives. However, the active sensor system used therein is heavy and expensive to operate, which limits its effectiveness in various operational situations.

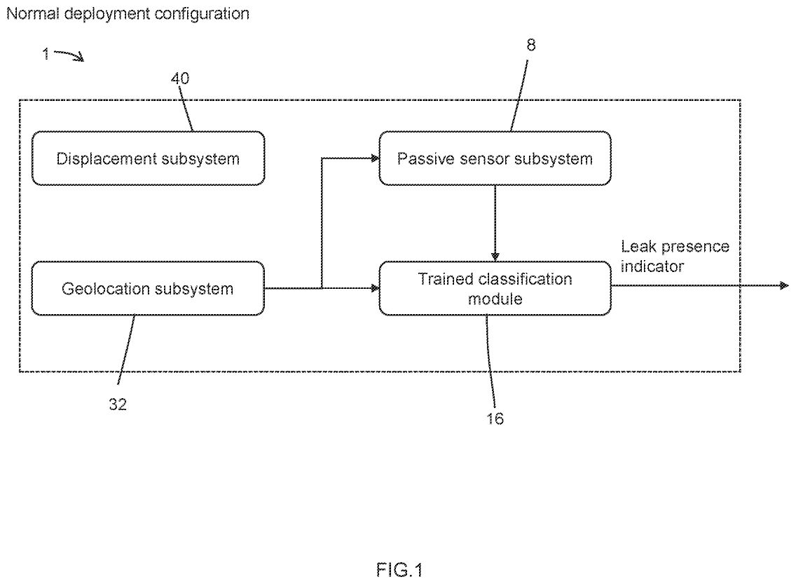

Referring now to FIG. 1, therein illustrated is a schematic diagram of the operational modules and/or subsystems of a leak detection system 1 according to an example embodiment. The system includes a passive sensor subsystem 8, which corresponds to a primary or first sensor subsystem of the leak detection system 1. The leak detection system 1 further includes a trained classification module 16 that receives sensed data captured by the passive sensor subsystem 8 and that is configured to apply a computer-implemented leak detection classification to the captured sensed data to classify samples of the sensed data as indicating a presence or a non-presence of leak of hazardous material.

The passive sensor subsystem 8 includes a set of one or more sensor devices that is operable to capture sensed samples of and/or at a plurality of geographic locations within a geographic region. The passive sensor subsystem 8 is denoted as being passive in that it takes measurements of signals incident on its sensor devices without initially itself emitting an active excitation signal. However, it is contemplated that in some example embodiments, at least one of the sensor devices of the passive sensor subsystem 8 can be an active sensor while other devices of the passive sensor subsystem 8 are passive.

The passive sensor subsystem 8 can be a multi-sensor subsystem, and can include one or more of a visible-light camera, an infrared camera, a multi-spectral camera, or a hyperspectral camera. The multi-sensor subsystem can be formed of commercially available off-the-shelf sensors.

At least one of the sensor devices of the passive sensor subsystem 8 captures sensed data in the form of 2D image data (in the visible range or outside the visible range).

The passive sensor subsystem 8 can be operable to capture sensed data that can be analyzed to make determinations of indications of presence of petroleum-based material. This determination can be made based on signatures in the frequency response contained in the captured sensed data. The computer-implemented classification module 16 is configured to receive captured samples from the passive sensor system 8 and to apply a classification algorithm to classify the captured samples as either indicating the presence of a leak of hazardous material or the non-presence of such a leak. It will be appreciated that carrying out the classification allows identifying when there is an occurrence of a potential leak and the geographical location of that potential leak. As described elsewhere herein, in one example embodiment, the computer-implemented classification module 16 can apply the classification algorithm to distinguish between true positive and false positive detections determined based on captured samples from the passive sensor system 8.

The computer-implemented classification module 16 can be configured to extract features from one or more samples of the sensed data captured by the passive sensor subsystem 8 and to classify each set of one or more samples as indicative of a presence of leak of hazardous material based on the extracted features. Accordingly, the computer-implemented classification module 16, when used in the normal deployment configuration, is a pre-trained (i.e. already trained) artificial intelligence-implemented classification module.

According to one example embodiment, and as illustrated in FIG. 1, the leak detection system 1 includes a geolocation subsystem 32, such as a GPS system. The GPS system can determine a current geographical location using an enhanced GPS signal. The current location determined by the geolocation subsystem 32 can be received by the passive sensor subsystem 8 such that each sample of the sensed data captured by the passive sensor subsystem 8 can be tagged with the geographical location where that sample was captured.

The current location determined by the geolocation subsystem 32 can also be received by the pre-trained classification module 16. The classification performed by the pre-trained classification module 16 can classify a given sample differently based on the geographical location where a given sample of the sensed data captured by the passive sensor system 8 was captured. For example, features can be extracted differently from the sensed data by the classification module 16 depending on the geographical location. Furthermore, filters, weights or the like that are applied within the classification can be applied differently by the classification module 16 depending on the geographical location. It will be appreciated that applying classification differently based on geographical location can take into account differences in terrain and presence of objects (ex: man-made objects) at different locations.

The leak detection system 1 illustrated in FIG. 1 corresponds to its normal or trained deployment configuration. In this configuration, the leak detection system 1 has already undergone training and/or calibration, and the system 1 is ready for frequent (ex: daily, weekly, monthly, etc.) operation in this configuration. In particular, in this configuration, the trained classification module 16 has already been trained. Furthermore, in this normal deployment configuration, the passive sensor subsystem 8 is the only set of one or more sensors of the system that captures sensed data to be used for leak detection. Typically, the leak detection system 1 will be operated regularly over a monitored geographical region. The monitored geographical region corresponds to a region having assets that need to be monitored for leak of hazardous material.

As described hereinabove, the classification module 16 is appropriately trained prior to deployment in its normal deployment configuration as illustrated by example in FIG. 1. The classification module 16 is trained by applying a machine learning algorithm to a training captured sensed dataset (i.e. validated training dataset) that includes data samples previously captured by the passive sensor subsystem 8 or by similar sensing equipment (i.e. equipment capturing samples that have a sufficient relevancy to samples captured by the passive sensor subsystem 8), such as in a previous sensing operation. The data samples of the training dataset can include samples previously captured by the passive sensor subsystem 8 of the plurality of geographical locations of the monitored geographic region where the leak detection system 1 is to be deployed. The training samples can also include data captured at other geographical regions.

The data samples of the training dataset may be each annotated as indicating the presence or non-presence of a leak. Accordingly, the classification module 16 is trained by supervised learning. Each sample can be annotated automatically for presence or non-presence of a leak based on the application of a secondary or second detection method. This second detection method is applied to second sensed data captured by a second sensor subsystem that is separate from the passive sensor subsystem 8. The second detection method can be applied automatically (i.e. with no human supervision, or minimal human supervision).

In another example embodiment, and as described herein, the annotation indicating the presence or non-presence of a leak can include annotating the data samples of the training dataset to indicate a true positive detection (actual presence of a leak) or false positive detection (non-presence of a leak).

The second sensed data captured by the second sensor subsystem is related to the passive sensor subsystem 8 even though the second sensed data is captured separately. The relationship can be a geographical relationship. Furthermore, the relationship can be a temporal relationship. For example, a given sample of the sensed data captured by the passive sensor subsystem 8 and a corresponding sample of the second sensed data have a geographical relationship if the two samples are captured at respective geographical locations that are sufficient close to each other such that the two samples are relevant with one another. Similarly, a given sample of the sensed data captured by the passive sensor subsystem 8 and a corresponding sample of the second sensed data have a temporal relationship if the two samples are captured sufficiently close in time such that they are relevant with one another. It will be appreciated a large gap in time or an intervening event occurring between the times when the samples were captured can cause the samples to no longer be temporally relevant.

According to one example, for a sample of the training dataset captured by the passive sensor subsystem 8 for a given geographical location, that given sample is annotated according to the indicator of presence or non-presence determined from applying the second detection method to a corresponding sample of the second sensed data captured by the second sensor subsystem for a geographically related location (ex: same geographical location). Each sample of the training dataset can be annotated by the outcome of the second detection method applied to a corresponding sample (i.e. geographically and temporally relevant location) captured by the secondary sensor subsystem. Furthermore, for the sample of the training dataset captured by the passive subsystem 8 for the given geographical location, it is annotated according to the outcome of the secondary detection method applied to a sample captured at the geographically related geographical location (ex: same geographical location). The sample from the secondary sensor subsystem 208 can also be captured at the temporally related point in time (ex: at the same time or sufficiently close in time). In other words, each given sample of the validated training dataset is annotated by the outcome of the secondary leak detection method applied to a sample captured by the second sensor subsystem having a temporal and/or geographical relationship to the given sample of the training dataset.

The secondary detection method can be applied automatically (i.e. without human supervision) on samples of the second sensed data captured by the second sensor subsystem. Moreover, using the outcome of the second detection method for each sample of a subset of the samples of the second sensor dataset, the sample of the training dataset corresponding to that sample of the second sensor data can also be automatically annotated with that outcome (i.e. the indication of presence or non-presence of a leak as determined by applying the secondary detection method).

The training of the classification module 16 using supervised learning and according to the training dataset can be carried out using various machine learning or deep learning techniques. In one example embodiment, the classification module 16 can apply a neural network, such as a convolution neural network, that is prebuilt and/or pretrained using the training dataset. A deep learning algorithm can be applied to train the classification module 16 using the training dataset having been annotated. On a coarser level, an object detection algorithm, such as YOLO (https://arxivm<DOT>org/abs/1506<DOT>02640) [1] can be trained to identify patches of images captured by the first sensor subsystem that are representative of a leak of liquid hydrocarbon. On a finer level, semantic segmentation algorithms, such as Fast R-CNN (https://arxiv<DOT>org/abs/1504<DOT>08083) [2] or U-Net architecture (https://arxiv<DOT>org/abs/1505 <DOT>04597) [3] (with <DOT> above replaced with in the actual URL), can be used to precisely identify pixels of images captured by the first sensor subsystem that is representative of a leak of liquid hydrocarbon, Such algorithms make use of convolutional neural networks architecture; which has been shown to outperform human capacity in detecting elements within images in different contexts.

According to one example embodiment, the secondary detection method applied to the second sensed data captured by the second sensor subsystem is a threshold-based detection method. That is, the secondary detection method determines the indication of presence or non-presence based on comparing the values of the samples of the captured second sensed data against one or more predetermined thresholds. For example, an AI-implemented classification module does not need to be used for the second sensed data. The threshold-based detection method can be spectrometric, such as looking at whether levels at various frequencies or frequencies band exceed frequency-specific thresholds.

According to one example embodiment, the second sensor subsystem includes at least one active sensor.

According to one example embodiment, the second sensor subsystem is effective for sensing a level of a petroleum-derived volatile organic compound. The VOC can be benzene, toluene, ethylbenzene, and xylene, or another VOC that may be derived from the petroleum product. The second sensor subsystem can include an ultraviolet radiation generator for illuminating a distant target with a UV radiation beam having an excitation wavelength being tuned to a resonance Raman excitation wavelength of the petroleum-derived volatile organic compound.

The second sensor subsystem can be the sensor system described in U.S. Pat. No. 10,113,953 and the secondary detection method applied to the second sensed data and used for annotating the training dataset can be the detection method described in the same U.S. patent. It will be appreciated that the detection method is a threshold-based method.

Returning to FIG. 1, the leak detection system 1 further includes a displacement subsystem 40, which may be of a first configuration, for carrying and displacing the passive sensor subsystem 8 over the monitored geographical region. The passive sensor subsystem 8 can be loaded onto the displacement subsystem 40 and operated to capture the samples of the second dataset as the displacement subsystem 40 moves over the plurality geographical locations within the monitored geographical region. The displacement subsystem 40 of the first configuration can be an aerial vehicle or a land-based vehicle. In one example embodiment, the aerial vehicle can be an unmanned aerial vehicle, such as a drone.

In one example embodiment, the passive sensor subsystem 8 used in its normal deployment configuration (whereby the trained classification module 16 classifies samples captured by the subsystem 8 to indicate leaks) has a total payload of less than 100 lbs. In some examples, the total payload may be less than 10 lbs, which allows the displacement subsystem 40 carrying the passive sensor subsystem 8 to be a drone.

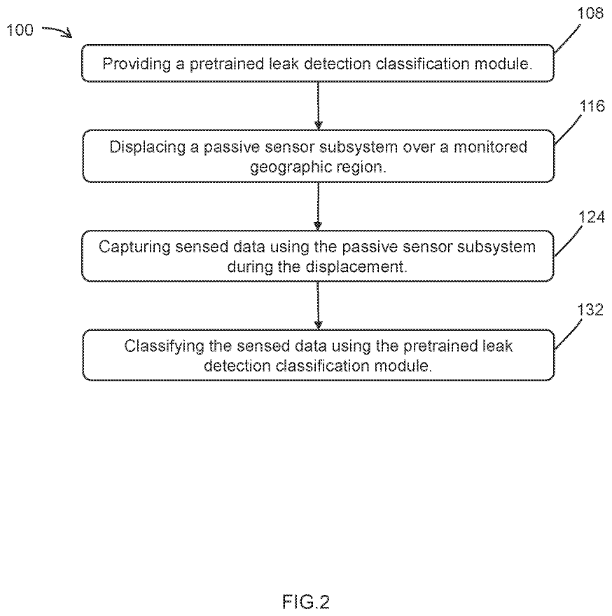

Referring now to FIG. 2, therein illustrated is a flowchart showing the operational steps of a method 100 for determining an indication of a presence of a leak of hazardous material according to one example embodiment. It will be understood that the method 100 can be carried out using the system 1 in its normal deployment configuration as illustrated in FIG. 1.

At step 108, the trained classification module 16 is provided. When provided, the module 16 has already been trained using the validated training dataset as annotated based on the secondary leak detection applied to sensed data captured by the secondary sensor subsystem.

At step 116, the passive sensor subsystem 8 is displaced over the monitored geographical region. This displacement can be carried out by operating the displacement subsystem 40.

At step 124, the passive sensor subsystem 8 is operated to capture samples of a plurality of geographical locations of the monitored geographical region as the passive sensor subsystem 8 is displaced. The captured samples can have a geographical correspondence with the samples of validated training dataset used to train the classification module 16.

At step 132, the samples of the sensed data captured by the passive sensor subsystem 8 are classified by the pretrained classification module 16. Samples classified as indicating the presence of a leak of hazardous material are identified and may be used to determine further action, such as carrying out more in-depth inspection (ex: deploying an inspection crew) of the potential leak site.

As described elsewhere herein, an initial detection of the indication of presence of petroleum-based material can be made on the samples captured by the passive sensor subsystem 8. For those samples indicating the presence of petroleum-based material, the classification module 16 can be further applied to classify each of these samples as representing a true positive indication of leak of hazardous material or a false positive indication of leak of hazardous material.

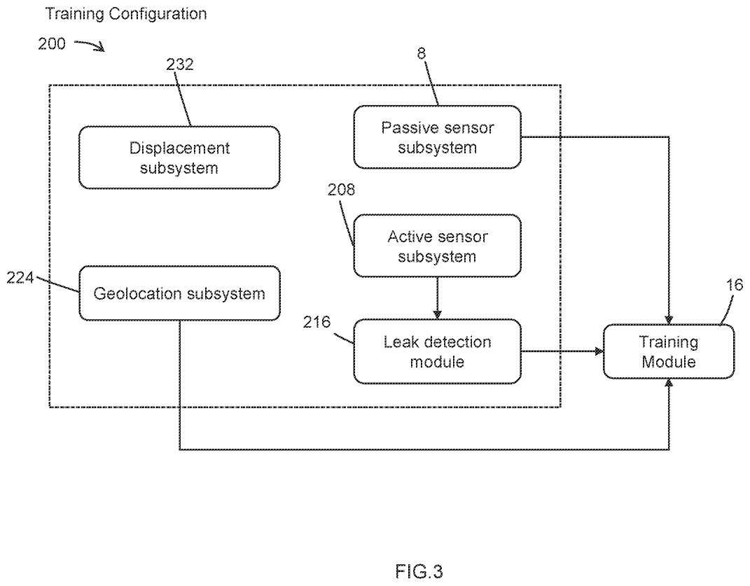

Referring now to FIG. 3, therein illustrated is a schematic diagram of the operational modules and/or subsystems of a leak detection system 200 in its training/calibration configuration according to an example embodiment. The training-configured system 200 includes a first sensor subsystem that is operable to capture sensed data of a plurality of locations of the monitored geographical location. The samples of the sensed data captured by the first sensor subsystem of the system 200 will be used as the training dataset for training the classification module 16. It will be understood that the sensed data captured by the first sensor subsystem are initially non-annotated. According to one example embodiment, and as illustrated, the first sensor subsystem can be the passive sensor subsystem 8. That is, the passive sensor subsystem 8 can be used both for capturing the data, during training, to be used as the training dataset and for capturing the data, in subsequent runs during normal deployment, for leak detection.

The training-configured system 200 further includes a second sensor subsystem 208 that is operable to capture secondary sensed data. The secondary leak detection is applied to samples of the secondary sensed data and the outcome (presence of leak or non-presence of leak) is used to annotate corresponding samples of the sensed data captured by the first sensor subsystem 8 to be used as the training dataset.

According to one example embodiment, the second sensor subsystem 208 is active.

According to one example embodiment, the second sensor subsystem 208 is effective for sensing a level of a petroleum-derived volatile organic compound. The VOC can be benzene toluene, ethylbenzene, xylene, or another VOC that may be derived from the petroleum product. The second sensor subsystem can include an ultraviolet radiation generator for illuminating a distant target with a UV radiation beam having an excitation wavelength being tuned to a resonance Raman excitation wavelength of the petroleum-derived volatile organic compound.

The second sensor subsystem 208 can be the sensor system described in U.S. Pat. No. 10,113,953 and the secondary detection method applied to the second sensed data and used for annotating the training dataset can be the detection method described in the same U.S. patent.

The first sensor subsystem 8 and the second sensor subsystem 208 can be operated such that samples captured by the two subsystems have a geographical and temporal relationship. For example, the sensor subsystems 8 and 208 can be operated at substantially the same time. More particularly, when capturing a sample by the first sensor subsystem 8 of a given geographical location, a corresponding sample is also captured by the second sensor subsystem 208. These two samples have temporal and geographical correspondence. The outcome of the secondary detection method applied to the second sample (captured by the second sensor subsystem 208) is used to annotate the corresponding sample captured by the first sensor subsystem 8. Alternatively, and as described elsewhere herein, the sensor subsystems 8 and 208 can be operated in separate runs but in a way such that the samples captured by the first sensor subsystem 8 and the samples captured by the second sensor subsystem 208 are geographically and temporally related.

The training-configured system 200 further includes a leak detection module 216 that receives samples of the second sensed dataset captured and outputted by the active sensor subsystem 208. The leak detection module 216 applies the secondary leak detection to each sample and outputs for that sample an indication of a presence or non-presence of a leak.

As illustrated, the samples of the first sensed data captured by the first sensor subsystem 8 are received by the classification module 16 as the training dataset. The indication of the presence/non-presence of a leak are received by the classification module 16 for annotating the received training dataset. As described elsewhere herein, each sample of the training dataset is annotated by the leak detection outcome applied to a corresponding (in time and in location) sample of the second dataset. The validated training set as annotated is used to train the classification module 16. Once trained in this way, the classification module 16 is ready for normal deployment, such as within the configuration of the system 1 described with reference to FIG. 1.

Continuing with FIG. 3, the training-configured leak detection system 200 further includes a geolocation subsystem 224, such as a GPS system having enhanced GPS signals. The current location determined by the geolocation subsystem 224 can be received by the first sensor system 8, the active sensor subsystem 208 and the training module. Each sample of the sensed data captured by the passive sensor subsystem 8 can be tagged with the geographical location where that sample was captured. Each sample of the sensed data captured by the second sensor subsystem 208 can also be tagged with the geographical location. Accordingly, for each given geographic location, the sample captured by the passive sensor subsystem 8 and the sample captured by the second sensor subsystem 208 are each associated to the same geographic identifier for that geographic location. The geographical identifier of the samples can be used to determine correspondence between a sample of the training dataset and an outcome of the secondary leak detection outputted by the secondary leak detection module 216.

The current location determined by the geolocation subsystem 224 can also be received by the classification module 16 when being trained. The classification module 16 can learn, during training, to extract features differently based on the geographical location of a training sample and its annotation for presence or non-presence. Furthermore, filters, weights or the like that are applied within the classification can be applied differently by the classification module 16 depending on the geographical location.

The training-configured leak detection system 200 may further include a displacement subsystem 232, which may be of a second configuration. The displacement subsystem 232 is operable to carry and displace at least the active sensor subsystem 208.

In one example embodiment, the displacement subsystem 232 can also be configured to carry and displace both the first sensor subsystem 8 and the active sensor subsystem 208 at the same time. The first sensor subsystem 8 and the second sensor subsystem 208 are both loaded onto the displacement subsystem 232 and both subsystems 8, 208 are operated to capture respective samples at the same time over the plurality of geographical locations with the monitored geographical region. The displacement subsystem 232 of the first configuration can be aerial vehicle or a land-based vehicle. Due to the added weight of the second sensor subsystem 208, the displacement subsystem 232 of the training-configured system 200 is specified to be able to carry a much heavier payload than the displacement subsystem 40 of the normal deployment system 1. For example, the displacement subsystem 232 of the training-configured system can have a capacity to carry a payload greater than 100 lbs. In some examples, the displacement subsystem 232 can have a payload capacity in the range of about 600 lbs. Upon completion of the training, the system in its normal deployment configuration 1 can be operated in further runs without the second sensor subsystem 208. It will be appreciated that the further runs will require only the displacement subsystem 40 having a lesser payload requirement, which can reduce cost of operation.

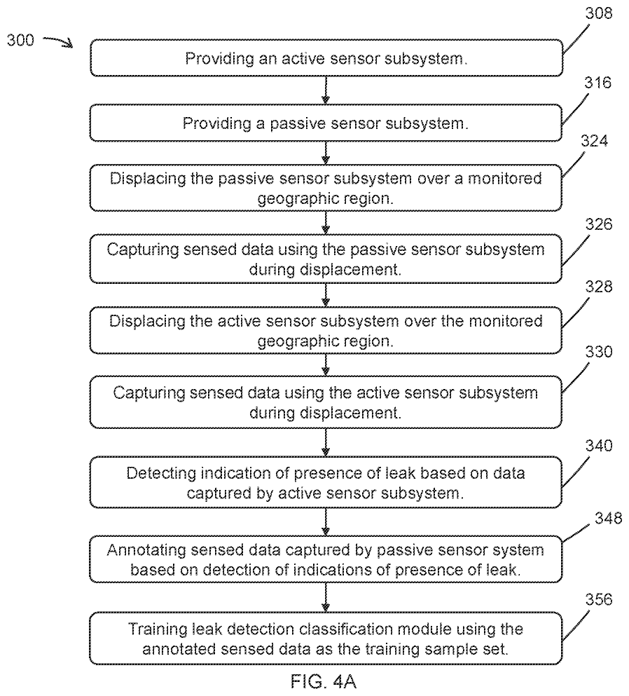

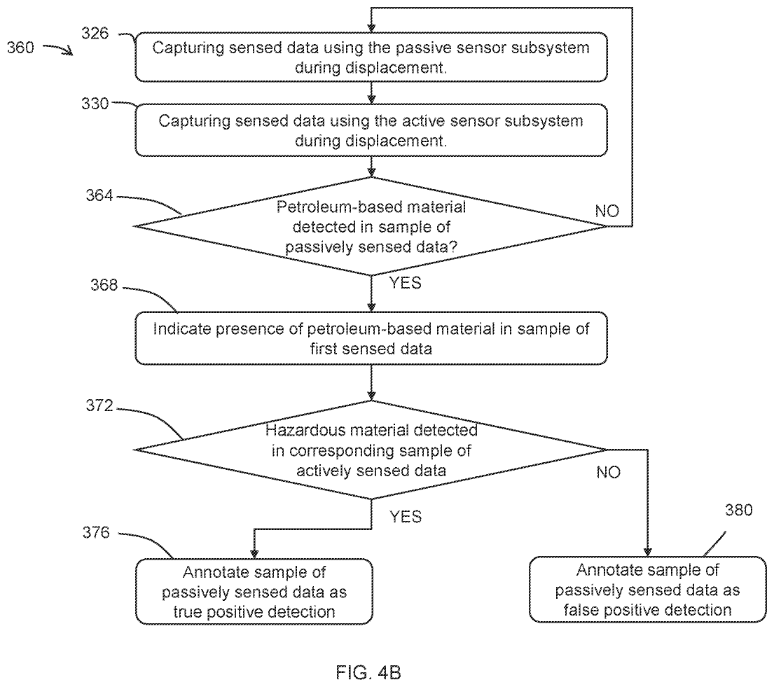

Referring now to FIG. 4A, therein illustrated is a flowchart showing the operational steps of a method 300 for determining an indication of a presence of a leak of hazardous material in a training mode according to one example embodiment. It will be understood that the method 300 can be carried out using the system 200 in its training configuration as illustrated in FIG. 3.

At step 308, the active (second) sensor subsystem 208 is provided. This step may include loading the second sensor subsystem 208 onto the displacement subsystem 232.

At step 316, the passive (first) sensor subsystem 8 is provided. This step may include loading the first sensor subsystem 8 onto the displacement subsystem 232. Alternatively, the passive sensor subsystem 8 can be loaded onto another displacement subsystem that is operated in a separate run from the displacement of the active sensor subsystem 208.

At step 324, the first sensor subsystem 8 is displaced over the monitored geographic region.

At step 326, the first sensor subsystem 8 is operated to capture samples of a first sensed data, which becomes the non-annotated training set.

At step 328, the second sensor subsystem 208 is displaced over the monitored geographic region.

At step 330, the second sensor subsystem 208 is operated to captured samples of a second sensed data, which will be used to annotate the training set.

It will be understood that the order of steps 324 to 330 can be different in different configurations. For example, the second sensor subsystem 208 can be displaced at step 328 before displacement of the first sensor subsystem 8 at step 324. Alternatively, both first and second sensor subsystems 8 and 208 can be displaced together within a single run, such that steps 324 and 328 are carried out at the same time. These may be displaced by displacement subsystem 232.

Similarly, the capturing of the second sensed data at step 330 can be carried out before the capturing of first sensed data at step 326. Alternatively, both first and second sensed data can be captured at the same time where both first and second sensor subsystems 8 and 208 are displaced together in a single run.

At step 340, the secondary leak detection method is applied to samples of the second sensed data captured by the second sensing subsystem 208. For each sample of the second sensed data, the secondary leak detection module 216 outputs an indication of presence/non-presence of leak of hazardous material for that sample.

At step 348, each sample of the first sensed data captured by the first sensing subsystem 8 is annotated with an indication of presence/non-presence of leak according to the indication outputted by the secondary leak detection module 216 for a corresponding sample of the second sensed data. As described herein, a sample of the first sensed data and a sample of the second sensed data correspond if they are captured in a way that has a geographical and temporal relationship. The annotated first sensed data becomes the validated training dataset.

At step 356, the classification module 16 is trained using the validated training dataset formed at step 348.

According to one example embodiment, the classification module 16 is trained to be configured to classify samples of the first sensed data according to whether a sample represents a true positive indication of presence of a leak or a false positive indication of presence of a leak. According to this embodiment, as part of step 326 or subsequent to step 326, each given sample of the first sensed data captured by the first sensor subsystem 8 is analyzed. This analysis is applied to the given sample to determine an indication of a presence of a petroleum-based material for the given sample. As described elsewhere herein, this determination can be based on analysis of signatures in the frequency response of the sample, whereby the signatures can be indicative of the presence of the petroleum-based material. As also described elsewhere herein, this initial determination can be correlated to a presence of leak of hazardous material, but is prone to determining false positives (i.e. a situation where the indication of the presence of the petroleum-based material is detected from analyzing the sample of the first sensed data, but that an actual leak of hazardous material is not present).

Accordingly, at step 348, each sample of the first sensed data captured by the first sensing subsystem 8, and for which a positive indication of the presence of the petroleum-based material has been determined, is further annotated based on the indication of presence or non-presence of a leak according to the indication outputted by the secondary leak detection module 216 for the corresponding sample of the second sensed data. This corresponding sample of the second sensed data can be one captured at the same geographic location as the given sample of the first sensed data. More particularly, if the given sample of the first sensed data having the indication of presence of petroleum-based material and if the corresponding sample of the second sensed data does not have an indication of the presence of the leak, the given sample of the first sensed data is annotated as being a false positive detection.

It will be appreciated that applying the annotation to the samples of the first sensed data has the effect of marking some samples as indicating the presence of petroleum-based material, but not having been annotated as being a false positive detection. These samples can be treated as a true positive indication of a presence of leak. That is, the lack of annotation thereof has the effect of annotating these samples as true positive detections.

Furthermore, it will be appreciated that carrying out the annotation in this manner to each sample of the first sensed data having an indication of the presence of petroleum-based material also has the effect of creating two classes of samples. The first class is formed of samples of the first sensed data determined as having the presence of the petroleum-based material and not being annotated as being a false positive detection. The second class is formed of samples of the first sensed data determined as having the presence of the petroleum-based material and being annotated as being a false positive detection. These two classes of samples form the training captured sensed dataset (i.e. validated training dataset) used to train the classification module 16. When trained based on this dataset, the classification module 16 can be operated (ex: in its normal operational configuration 1) to classify subsequently captured first samples that have an indication of presence of petroleum-based material as either being a true positive detection or a false positive detection.

It will be understood that in some embodiments, a given sample of the first sensed data having the indication of the presence of petroleum-based material can also be actively annotated as a true positive if the corresponding sample of the second sensed data has an indication of the presence of the leak.

It will be appreciated the classification module 16 configured in this manner can provide the advantage of overcoming drawback of available systems that have high rate of false positives. Whereas relying solely on the detection of indications of presence of petroleum-based material has the drawback of high rate of false positives (due to other sources of petroleum), the further classification by the trained classification module 16 has the effect of identifying the false positives and the true positives. This allows an operator to respond more selectively and accurately only to the true positives, such as by only carrying out further examination for true positives and ignoring the false positives. It will be further appreciated that this higher accuracy rate (lower rate of false positives) is achieved by using the classification module 16 and eliminates the need to use the second (active) sensor subsystem 208 that is more costly to operate.

Referring now to FIG. 4B, therein illustrated is a flowchart showing the operational steps of a method 360 for annotating first sensed data captured by the first sensing subsystem 8 to indicate whether samples of the first sensed data are a true positive detection or a false positive detection. The method can be carried out as part of the training of the leak detection module 216 and forms part of the steps of method 300 illustrated in FIG. 4A.

At steps 326 and 330, a given sample of the first sensed data is captured by the first (passive) sensor subsystem 8 and a corresponding sample of the second sensed data is captured by the second (active) sensor subsystem 208.

At step 364, the sample of the first sensed data is analyzed to determine if it contains an indication of presence of petroleum-based material. If no indication of petroleum-based material is determined, the sample may be discarded and the method returns to step 332 to receive or capture another sample.

If the analysis determines that there is an indication of presence of petroleum-based material, the method proceeds to step 368 to mark the given sample of the first sensed data as having the indication of the petroleum-based material.

At step 372, the sample of the second sensed data corresponding to the given sample of first sensed data (ex: captured at the same geographical location and/or at the same time) is retrieved. From performing step 340, it is determined whether this corresponding sample of the second sensed data has an indication of presence of leak of hazardous material.

If it is determined at step 372 that the corresponding sample of the second sensed data has an indication of presence of leak of hazardous material, the method moves to step 376 and the given first sample of first sensed data is annotated as being a true positive. This sample can be included in the first class of the training captured sensed dataset.

If it is determined at step 372 that the corresponding sample of the second sensed data does not have an indication of presence of leak of hazardous material, the method moves to step 380 and the given first sample of the first sensed data is annotated as being a false positive. This sample can be included in the second class of the training captured sensed dataset.

The method 360 can then be repeated for another sample of the first sensed data, such as by capturing further data at steps 326 and 330 or analyzing another sample of the first sensed data step 364.

According to various example embodiments, additional data captured for a given geographical location can be used to confirm whether a given sample of the first sensed data having an indication of presence of petroleum-based material is a true positive detection or a false positive detection of an indication of presence of leak of hazardous material. For the geographical location, data may be captured and objects represented within the data and present at the geographical location can be detected and classified. For example, a visible-light image, infrared image, or other spectral range, can be taken of the geographical location can be taken. Objects present in the image can be detected and classified according to known image classification techniques. In one example embodiment, if an object known to be emitters of hazardous materials (ex: rail car containers carrying petroleum products—since a leak from such containers would have the same signature as a pipeline leak) are detected, the identification of this object can be used to confirm a true positive detection. In one example embodiment, if an object known to have hydrocarbons but do not represent leaks of hazardous material (ex: emissions from a farm containing livestock), this identification of this object can be used to confirm a false positive detection.

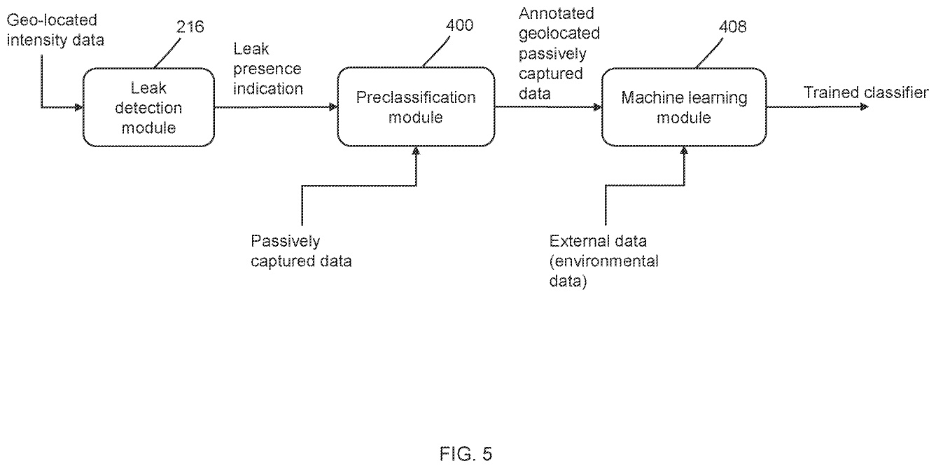

Referring now to FIG. 5, therein illustrated is a schematic diagram showing the logical flow of captured data and processed data for training the leak detection classification module according to an example embodiment.

The second sensed data captured by the secondary sensing subsystem 208 is fed to the secondary leak detection module 216. For each sample, the leak detection module 216 outputs an indication of presence or non-presence of leak.

The indications for these samples and the first sensed data captured by the first sensing subsystem 8 are fed to a pre-classification module 400. This module annotates each sample of the first sensed data based on the indication of the corresponding sample of the second sensed dataset. This annotated sensed dataset forms the validated training dataset.

The validated training dataset and any pertinent external data (ex: geographical, environment data, pre identified features, known man made structures) are fed to the machine learning module 408, which learns features from the training dataset and how to classify them based on the annotation of the samples of the validated training dataset. A trained classification module 16 is outputted, whereby the module is ready for deployment.

In an example operation for monitoring a geographical region for leaks of hazardous material, the training-configured system 200 is initially operated. This initial operation includes displacing the first sensor subsystem 8 and the second sensor subsystem 208 over a plurality of geographical locations within the monitored geographical region. As described elsewhere herein, the samples captured by the first sensor subsystem becomes the training dataset. The samples captured by the second sensor subsystem are used to automatically annotate the training dataset. A secondary leak detection module is applied to each sample of the second sensed data to obtain an indicator of presence or non-presence of leak, which is then used to annotate the corresponding sample of the training dataset. The annotated training dataset is used to train, by supervised learning, the classification module 16. This initial operation is costly due to the weight and the cost of operation of the active sensor subsystem 208, but the initial operation allows capturing the data to train the classification module 16.

Once the classification module 16 is properly trained, the regular monitoring of the geographical region can be carried out by displacing the passive (first) sensor subsystem 8 without the active (second) sensor subsystem. The samples captured by the passive sensor subsystem 8 are classified by the trained classification module 16 and indications of presence of leak are identified. These indications can be used to determine whether further analysis is required. Since the passive sensor subsystem 8 is lighter and less costly to operate, this regular monitoring can be carried out more frequently.

Once in a while (significantly less frequently than operation in the regular monitoring, ex: on a yearly basis), the training-configured system 200 can be operated to retrain the classification module 16. This can ensure that the classification module 16 is brought up-to-date, for example, to account for changes in the monitored geographical region.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

### REFERENCES

1. Redmon, J., Divvala, S. Girshick, R., & Farhadi, A. (2016). You only look once: Unified, real-time object detection. In Proceedings of the IEEE conference on computer vision and pattern recognition (pp. 779-788).
2. Ren, S., He, K., Girshick, R., & Sun, J. (2015). Faster r-cnn: Towards real-time object detection with region proposal networks. In Advances in neural information processing systems (pp. 91-99).
3. Ronneberger, O., Fischer, P., & Brox, T. (2015, October). U-net: Convolutional networks for biomedical image segmentation. In international Conference on Medical image computing and computer-assisted intervention (pp. 234-241). Springer, Cham.

What is claimed is:

1. A method of determining an indication of a presence of a leak of hazardous material, the method comprising:
displacing a first sensor system over a monitored geographic region;
capturing first sensed data of the monitored geographic region using the sensor system during displacement of the first sensor system; and
classifying the sensed data using a computer-implemented classification module, thereby identifying one or more sensed samples of the sensed data having an indication of the presence of leak of hazardous material, the classification module being trained according to a training captured sensed dataset having samples being automatically annotated to indicate presence or non-presence of a leak based on applying a detection method to second sensed data captured by a second sensor system of the monitored geographic region.

2. The method of claim 1, wherein for each of a given sample of the training captured sensed dataset being captured for a given geographical location of the monitored geographic region:
the given sample is annotated according to the indicator of presence or non-presence determined from applying the detection method to a corresponding sample of the second sensed data captured by the second sensor system for the same given geographical location.

3. The method of claim 2, wherein each given sample of the training captured sensed dataset and each corresponding sample of the second sensed data is captured at the same time and of the same geographical location.

4. The method any one of claims 1 to 3, wherein the training captured sensed dataset is captured by the first sensor system in a previous sensing operation.

5. The method of any one of claims 1 to 4, wherein for each given sample of the training captured sensed dataset, an analysis is applied to the given sample to determine an indication of a presence of a petroleum-based material for the given sample;
wherein each given sample having the indication of the presence of the petroleum-based material is annotated according to if no indication of the presence of the leak is determined for the sample of the second sensed data corresponding to the given sample, annotating the given sample as being a false positive detection.

6. The method of claim 5, wherein the training captured sensed dataset comprises:
i) a first class formed of samples determined as having the presence of the petroleum-based material and not being annotated as being a false positive detection; and
ii) a second class formed of samples determined as having the presence of the petroleum-based material and being annotated as being a false positive detection.

7. The method of claim 6, wherein samples of the training captured sensed dataset having the indication of the presence of petroleum-based material and not being annotated as being as a false positive detection is treated as a true positive indication of a presence of a leak.

8. The method of claim 6 or 7, wherein the computer-implemented classification module is configured to classify a given sample captured by the first sensor system and determined as indicating presence of the petroleum-based material as i) a true presence of a leak or ii) as a false positive presence of a leak.

9. The method of any one of claims 1 to 8, wherein the first sensor system is a multi-sensor system.

10. The method of any one of claims 1 to 9, wherein the first sensor system is passive.

11. The method of claim 10, wherein the first sensor system comprises at least one of a visible-light camera, an infrared camera, one or more multi-spectral cameras or a hyperspectral camera.

12. The method of any one of claims 1 to 11, wherein the detection method applied to the second sensed data is a threshold-based detection method.

13. The method of any one of claims 1 to 12, wherein the second sensor system comprises at least one active sensor.

14. The method of claim 13, wherein the second sensor system is effective for sensing a level of a petroleum-derived volatile organic compound.

15. The method of claim 14, wherein the petroleum-derived volatile organic compound is one or more of benzene, toluene, ethylbenzene, and xylene.

16. The method of claim 15, wherein the second sensor system comprises an ultraviolet radiation generator operable to illuminate a distant target with a UV radiation beam having an excitation wavelength being tuned to a resonance Raman excitation wavelength of the petroleum-derived volatile organic compound.

17. The method of any one of claims 1 to 16, wherein the first sensor system is displaced by an aerial vehicle or a land-based vehicle.

18. The method of claim 17, wherein the aerial vehicle is an unmanned aerial vehicle.

19. A method for determining an indication of a presence of a leak of hazardous material, the method comprising:
displacing a first sensor system and a second sensor system over a monitored geographic area;
during displacement over the monitored geographic area, capturing sensed data at a plurality of geographic locations of the geographic area using the first sensor system and the second sensor system, for each geographic location, the first sensor system outputting a first sensed sample and the second sensor system outputting a corresponding second sensed sample,
for each of a subset of the second samples:
automatically determining an indication of a presence of a leak for a given geographical location based on the second sensed sample captured for said given geographical location;
automatically annotating the first sensed sample corresponding to the second sensed sample with the indication of presence of leak determined for the second sensed sample; and
training a computer-implemented classification module based on the first sensed samples having been annotated according to the determination of indication of presence of leak made based on the second sensed samples.

20. The method of claim 19, further comprising, for each given one of the first sensed samples outputted by the first sensor system, determining an indication of a presence of a petroleum-based material for the given first sensed sample;
wherein automatically annotating the first sensed sample corresponding to the second sensed sample for each of the subset of the second samples comprises if the indication of the presence of petroleum-based material is determined for the corresponding first sensed sample and no indication of the presence of the leak is determined for the second sensed sample, annotating the corresponding first sample as being a false positive detection.

21. The method of claim 20, wherein the automatically annotating forms a training set having:
i) a first class formed of first sensed samples determined as having the presence of the petroleum-based material and not being annotated as being a false positive detection; and
ii) a second class formed of second sensed samples determined as having the presence of the petroleum-based material and being annotated as being a false positive detection; and
wherein the computer-implemented leak detection module is trained based on the training set.

22. The method of claim 21, wherein the first sensed sample having the indication of the presence of petroleum-based material and not being annotated as being as a false positive detection is treated as a true positive indication of a presence of a leak.

23. The method of claim 21 or 22, wherein the computer-implemented classification module, upon completion of training, is configured to classify a given sample subsequently captured by the first sensor system and determined as indicating presence of the petroleum-based material as i) a true positive presence of a leak or ii) as a false positive presence of a leak.

24. The method of any one of claims 19 to 23, wherein each given first sample and each corresponding second sample are captured at the same time and of the same geographical location using the first sensor system and the second sensor system.

25. The method of any one of claims 19 to 24, wherein for each given geographic location, the first sensed sample and the second sample captured at the given geographic location are each associated to a geographic identifier for given the geographic location.

26. The method of any one of claims 19 to 25, wherein a given first sample and a given second sample each being associated to the same geographic identifier have a correspondence during the automatically annotating.

27. The method of any one of claims 19 to 26, wherein the first sensor system is a multi-sensor system.

28. The method of any one of claims 19 to 27, wherein the first sensor system is passive.

29. The method of claim 28, wherein the first sensor system comprises at least one of a visible-light camera, an infrared camera, one or more multi-spectral cameras or a hyperspectral camera.

30. The method of any one of claims 19 to 29, wherein the detection method applied to the second sensed data is a threshold-based detection method.

31. The method of any one of claims 19 to 30, wherein the second sensor system comprises at least one active sensor.

32. The method of claim 31, wherein the second sensor system is effective for sensing a level of a petroleum-derived volatile organic compound.

33. The method of claim 32, wherein the petroleum-derived volatile organic compound is one or more of benzene, toluene, ethylbenzene, and xylene.

34. The method of claim 33, wherein the second sensor system comprises an ultraviolet radiation generator operable to illuminate a distant target with a UV radiation beam having an excitation wavelength being tuned to a resonance Raman excitation wavelength of the petroleum-derived volatile organic compound.

35. The method of any one of claims 19 to 34, further comprising:
displacing, in an additional run, the first sensor system over the monitored geographic region;
capturing, during the additional run, sensed data of the monitored geographic region using the first sensor system;
classifying the sensed data using the computer-implemented classification module, thereby identifying one or more sensed samples of the sensed data, captured in the additional run, having an indication of presence of leak of hazardous material.

36. The method of claim 35, wherein in the additional run, the first sensor system is displaced in a vehicle without the second sensor system.

37. A system for determining an indication of a presence of a leak of hazardous material, the system comprising:
a first sensor subsystem configured to capture first sensed data of a monitored geographic region; and
a computer-implemented classification module configured to classify the sensed data to identify one or more sensed samples of the sensed data having an indication of the presence of leak of hazardous material, the classification module being trained according to a training captured sensed dataset having samples being automatically annotated to indicate presence or non-presence of a leak based on applying a detection method to second sensed data captured by a second sensor subsystem of the monitored geographic region.

38. The system of claim 37, further comprising a displacement platform for displacing the first sensor subsystem over the monitored geographic region.

39. The system of claim 38, wherein the displacement platform is an aerial vehicle or a land-based vehicle.

40. The system of claim 39, wherein the aerial vehicle is an unmanned aerial vehicle.

41. The system of any one of claims 37 to 40, wherein each given sample of the training captured sensed dataset and each corresponding sample of the second sensed data is captured at the same time and of the same geographical location.

42. The method any one of claims 37 to 41, wherein the training captured sensed dataset is captured by the first sensor subsystem in a previous sensing operation.

43. The system of any one of claims 37 to 42, wherein for each given sample of the training captured sensed dataset, an analysis is applied to the given sample to determine an indication of a presence of a petroleum-based material for the given sample;
wherein each given sample having the indication of the presence of the petroleum-based material is annotated according to if no indication of the presence of the leak is determined for the sample of the second sensed data corresponding to the given sample, annotating the given sample as being a false positive detection.

44. The system of claim 43, wherein the training captured sensed dataset comprises:
i) a first class formed of samples determined as having the presence of the petroleum-based material and not being annotated as being a false positive detection; and
ii) a second class formed of samples determined as having the presence of the petroleum-based material and being annotated as being a false positive detection.

45. The system of claim 44, wherein samples of the training captured sensed dataset having the indication of the presence of petroleum-based material and not being annotated as being as a false positive detection is treated as a true positive indication of a presence of a leak.

46. The system of claim 44 or 45, wherein the computer-implemented classification module is configured to classify a given sample captured by the first sensor system and determined as indicating presence of the petroleum-based material as i) a true positive presence of a leak or ii) as a false positive presence of a leak.

47. The system of any one of claims 37 to 46, wherein the first sensor subsystem is a multi-sensor system.

48. The system of any one of claims 37 to 47, wherein the first sensor subsystem is passive.

49. The system of claim 48, the first sensor subsystem comprises at least one of a visible-light camera, an infrared camera, one or more multi-spectral cameras or a hyperspectral camera.

50. The system of any one of claims 37 to 49, wherein the detection method applied to the second sensed data is a threshold-based detection method.

51. The system of any one of claims 37 to 50, wherein the second sensor subsystem comprises at least one active sensor.

52. The system of claim 51, wherein the second sensor subsystem is effective for sensing a level of a petroleum-derived volatile organic compound.

53. The system of claim 52, wherein the petroleum-derived volatile organic compound is one or more of benzene, toluene, ethylbenzene, and xylene.

54. The method of claim 53, wherein the second sensor subsystem comprises an ultraviolet radiation generator operable to illuminate a distant target with a UV radiation beam having an excitation wavelength being tuned to a resonance Raman excitation wavelength of the petroleum-derived volatile organic compound.

55. A system for determining an indication of a presence of a leak of hazardous material, the system comprising:
a first sensor subsystem configured to capture first sensed data of a plurality of geographic locations of a monitored geographic region;
a second sensor subsystem configured to capture second sensed data of the plurality of geographic locations of the monitored geographic region, for each geographic location, the first sensor subsystem outputting a first sensed sample and the second sensor subsystem outputting a corresponding second sensed sample; and
a computer-implemented classification module configured to classify the first sensed data to identify one or more sensed samples of the sensed data having an indication of the presence of leak of hazardous material, the classification module being trained according to the first sensed samples having been automatically annotated according to the detection of indication of presence of leak made based on the second sensed samples.

56. The system of claim 55, wherein for each of a subset of the second samples:
an indication of a presence of leak for a given geographical location is automatically determined by applying a detection method on the second sensed sample captured for said given geographical location;
the first sensed sample corresponding to the second sensed sample is automatically annotated with the indication of presence of leak determined for the second sensed sample.

57. The system of claim 56, wherein for each given one of the first sensed samples outputted by the first sensor subsystem, an indication of a presence of a petroleum-based material for the given first sensed sample is determined;
wherein automatically annotating the first sensed sample corresponding to the second sensed sample for each of the subset of the second samples comprises if the indication of the presence of petroleum-based material is determined for the corresponding first sensed sample and no indication of the presence of the leak is determined for the second sensed sample, annotating the corresponding first sample as being a false positive detection.

58. The system of claim 57, wherein the automatically annotating forms a training set having:
i) a first class formed of first sensed samples determined as having the presence of the petroleum-based material and not being annotated as being a false positive detection; and
ii) a second class formed of second sensed samples determined as having the presence of the petroleum-based material and being annotated as being a false positive detection; and
wherein the computer-implemented leak detection module is trained based on the training set.

59. The system of claim 58, wherein the first sensed sample having the indication of the presence of petroleum-based material and not being annotated as being as a false positive detection is treated as a true positive indication of a presence of a leak.

60. The system of claim 58 or 59, wherein the computer-implemented classification module, upon completion of training, is configured to classify a given sample subsequently captured by the first sensor system and determined as indicating presence of the petroleum-based material as i) a true positive presence of a leak or ii) as a false positive presence of a leak.

61. The system of any one of claims 56 to 60, wherein each given first sample and each corresponding second sample are captured at the same time and of the same geographical location using the first sensor subsystem and the second sensor subsystem.

62. The system of any one of claims 56 to 61, wherein for each given geographic location, the first sensed sample and the second sample captured at the given geographic location are each associated to a geographic identifier for given the geographic location.

63. The system of any one of claims 56 to 62, wherein a given first sample and a given second sample each being associated to the same geographic identifier have a correspondence during the automatically annotating.

64. The system of any one of claims 55 to 63, further comprising a displacement platform for displacing the first sensor subsystem and the second sensor subsystem together over the monitored geographic region.

65. The system of claim 64, wherein the displacement platform is an aerial vehicle or a land-based vehicle.

66. The system of claim 64 or 65, wherein each given first sample of the first sensed data and each corresponding sample of the second sensed data is captured at the same time and of the same geographical location using the first sensor subsystem and the second sensor subsystem.

67. The system of any one of claims 55 to 66, wherein the first sensor subsystem is a multi-sensor subsystem.

68. The system of any one of claims 55 to 67, wherein the first sensor subsystem is passive.

69. The system of any one of claims 55 to 68, wherein the first sensor subsystem comprises at least one of a visible-light camera, an infrared camera, one or more multi-spectral cameras or a hyperspectral camera.

70. The system of any one of claims 55 to 69, wherein the detection method applied to the second sensed data is a threshold-based detection method.

71. The system of any one of claims 55 to 70, wherein the second sensor subsystem comprises at least one active sensor.

72. The system of claim 71, wherein the second sensor subsystem is effective for sensing a level of a petroleum-derived volatile organic compound.

73. The method of claim 51, wherein the petroleum-derived volatile organic compound is one or more of benzene, toluene, ethylbenzene, and xylene.

74. The method of claim 73, wherein the second sensor subsystem comprises an ultraviolet radiation generator operable to illuminate a distant target with a UV radiation beam having an excitation wavelength being tuned to a resonance Raman excitation wavelength of the petroleum-derived volatile organic compound.
